(19) United States
(12) Patent Application Publication
(10) Pub. No.: US 2002/0072911 A1
(43) Pub. Date: Jun. 13, 2002

(54) System and method for interactively tracking a patient in a medical facility

(75) Inventors: Kevin P. Kilgore, Eagan, MN (US); Vince P. Ales, North Saint Paul, MN (US)

Correspondence Address: MERCHANT & GOULD PC, P.O. BOX 2903, MINNEAPOLIS, MN, 55402-0903, US

(73) Assignee: Ramsey Foundation, St. Paul, MN

(21) Appl. No.: 09/793,315

(22) Filed: Feb. 26, 2001

Related U.S. Application Data
(63) Continuation of application No. 08/782,523, filed on Jan. 10, 1997, now abandoned.

(51) Int. Cl. G10L 21/00

(52) U.S. Cl. 704/270

(57) ABSTRACT

A computer system for registering and tracking a patient in a designated treatment area of a medical facility comprises input means for receiving data items including personal, treatment, and logistical information about the patient. Memory means are operably connected to the input means for storing the data items, and a processor is operably connected to the input means and the memory means for creating a record of the data items. the processor also configures the data items into a data structure that permits interactive tracking of the patient while admitted to the treatment area. A user interface is operably connected to the processor and displays the data items from the data structure. The user interface also allows a user to control the processor for and manipulate the data structure, thereby providing real-time logistical tracking of the patient.

### TECHNICAL FIELD

The present invention relates generally to tracking a patient and information related to the patient in a medical facility, and more specifically to a user friendly computer system and method for interactively tracking a patient and related information while the patient is admitted to the medical facility.

### BACKGROUND

Hospitals are an integral part of a community that provide a great service. Particularly, a hospital provides medical care to the people so they can carry on healthy and productive lives. The particular type of health care that each person in the community requires from the hospital is different. Some people who are treated at hospitals have medical conditions that develop gradually and are admitted to the hospital after examination from a doctor. Other people suddenly receive an injury or suddenly become ill. These people require emergency care. Thus, hospitals have emergency rooms where people are brought in order to receive immediate medical attention.

Because urban areas are often densely populated, hospital emergency rooms in these areas must have the capacity to treat a large number of people. Treating a large volume of patients in the fast-paced setting of an emergency room is very difficult and requires a tremendous amount of organization. Nevertheless, an emergency room must still provide high quality health care in an efficient manner.

In order to provide quality health care in an efficient manner, an emergency room must maintain different types of logs in order to track the patients. For example, emergency rooms need to register patients that are admitted and record various types of information until the patient is discharged. The emergency room must also keep track of those patients that have not yet been treated and identify the next patient that should get treatment when a doctor becomes available. To this end, a large hospital will also need to track the location of the patient so that the doctor can quickly identify him/her and provide medical care.

As stated above, a hospital must track various types of information related to each patient. Tracking this information is important so that the hospital management can analyze the performance of the emergency room and make informed management decisions that maintain or improve the quality of the health care. The information is also important because the Joint Commission on the Accreditation of Health Care Organizations (JCAHO), a federally recognized agency that is charged with hospital accreditation, requires each hospital to file reports in order to maintain its medicare and medicaid accreditation. A hospital that loses this accreditation can no longer receive reimbursements from these health care programs. The particular type of information that must be reported includes each patient's name, the name of the treating physician for each patent, the patient's initial complaint, the patient's diagnosis, the patients medical category and classification, the patient's disposition, the patient's admission and discharge times, and the hospital's identification number. This information must be tracked for each individual patient, which places a burden on the hospital and detracts from the need to provide efficient and quality health care.

Current methods for tracking patients as well as information about each patient are very crude and time consuming. Most emergency rooms use a combination of different systems in order to track the location of a patient as well as the various types of information related to the patient. An emergency room might have a chalk board for identifying patients that have not been treated and separate paper records for tracking the location of the patient. A whole separate system is required for registering the patient into the emergency room. Finally, there is no system for keeping track of the information that the hospital must report to the government. Most of this information is kept in the files and charts for each individual patient. Thus, an administrator must manually go through all of the records to compile the information for reporting purposes.

The current procedures for tracking patients and information related to the patients have many shortcomings. For example, a full-time administrative employee is often needed to compile information from the patients records and charts in order to complete and file the reports that are required by the government. The result is additional overhead that burdens the financial resources of the hospital. Another shortcoming is the time that is required to update the various tracking and record keeping systems, many of which require redundant information. The extra time required to coordinate information between the various tracking and record keeping systems takes time away from the patients. The results is that the efficiency and quality of health care is adversely affected. The need to keep different charts and tracking systems also results in discrepancies between the various records, which results in confusion. Again, this confusion affects the efficiency and quality of health care provided by the emergency room.

Therefore, there is a need for a system and method of tracking patients and information that removes administrative and time burdens from the emergency room. More particularly, there is a need for a single interactive system that is capable of tracking a patient from the time he/she is admitted to an emergency room until the time the patent is discharged. Such a system would also track information related to each patient's visit and thus provide a single, automated source compiling the information that the emergency room must file with the government.

### SUMMARY

One embodiment of the present invention provides a computer system for registering and tracking a patient in a designated treatment area of a medical facility. One possible designated treatment area includes an emergency room of a hospital. The computer system receives data items including personal, treatment and logistically information about the patient and stores these data items in a memory device. A processor creates a record for organizing the data items and then configures the data items into a data structure that permits interactive tracking of the patient while admitted to the treatment area. The computer system further includes a user interface that displays the data items from the data structure and also allows a user to control the processor. Controlling the processor to manipulate the data structure, thereby providing real time logistical tracking of the patient.

The present invention also provides a method of registering and tracking a patient on a computerized system in a designated treatment area of a medical facility. An example of the type of the treatment area that the method of this invention can be used, is the emergency room in the hospital. The initial step of the method is receiving the data items including personal, treatment and logistical information about the patient. These data items are then stored and a record for organizing the data items is created. The next step is configuring the data items into a data structure that permits interactive tracking of the patient while admitted to the treatment area. Next, the data items from the data structure are displayed, and a user is then allowed to manipulate the data structure, thereby providing real time logistical tracking of the patient.

These and other advantages and features which characterize the present invention are pointed out with particularity in the claims annexed hereto and forming of further part hereto. However, for a better understanding of the invention, its advantages, and objects obtained by its use, reference should be made (1) to the drawings that form a further part hereto; and (2) to the accompanying descriptive matter, which illustrates and describes a preferred embodiment of the present invention.

### DESCRIPTION OF THE DRAWINGS

FIG. 1 shows the interactive computer system of the present invention.

FIG. 2 shows the configuration of a terminal that forms a part of the computer system shown in FIG. 1.

FIG. 3 shows the configuration of the memory and flow of information within the file server that forms a part of the computer system shown in FIG. 1.

FIG. 4 shows the patient triage data structure and window that are created by the computer system shown in FIG. 1.

FIG. 5 shows the patient registration window that are created by the computer system shown in FIG. 1.

FIG. 6 shows the east bed assignments window and data structure that are created by the computer system shown in FIG. 1.

FIG. 7 shows the west bed assignments window and data structure that is created by the computer system shown in FIG. 1.

FIG. 8 shows the whose next board window and data structures that are created by the computer system shown in FIG. 1.

FIG. 9 shows the east end log window and data structures that are created by the computer system shown in FIG. 1.

FIG. 10 shows the west end log window and data structures that are created by the computer system shown in FIG. 1.

FIG. 11 shows the clinic log window and data structures that are created by the computer system shown in FIG. 1.

FIG. 12 shows the master log window and data structures that are created by the computer system shown in FIG. 1.

FIG. 13 shows the east record window and data structure that are created by the computer system shown in FIG. 1.

FIG. 14 shows the west record window and data structure that are created by the computer system shown in FIG. 1.

FIG. 15 shows the clinic record window and data structure that are created by the computer system shown in FIG. 1.

FIG. 16 shows the patient past visits window and data structures that are created by the computer system shown in FIG. 1.

FIG. 17 shows the unsigned charts window and data structures that are created by the computer system shown in FIG. 1.

FIG. 18 shows the main menu that is utilized by the computer system shown in FIG. 1.

FIG. 19 shows an information window that is created by the computer system shown in FIG. 1.

FIG. 20 shows a dialogue box that the user can access when the window shown in FIG. 8 is displayed by the computer system that is shown in FIG. 1.

### DETAILED DESCRIPTION

The invention will initially be described in general terms and the preferred embodiment of the invention will be described in detail with reference to the drawings, wherein like reference numerals represent like parts and assemblies throughout the several views. Reference to the preferred embodiment does not limit the scope of the invention, which is limited only by the scope of the claims that may be interpreted according to the doctrine of equivalents.

The present invention provides a computer system and a method for interactively tracking patients in a treatment area of a hospital. The interactive system and method involve inter-related databases that store data items related to personal, treatment, and location information about each patient. The information for each patient's visit is stored in a separate record. A user interacts with the computer system in order to selectively create and view a data structure. Additionally, a user can edit data items that are contained in the data structure. Each data structure contains a certain combination of the data items stored in the record. This system and method provides flexibility to the medical staff so they can receive real time logistical information about each patient in a variety of formats. The system and method also provides a way to constantly update administrative information in a central location as certain events happen. Thus, the system and the method of the present invention provides a very powerful tool that permits the medical facility to operate much more efficiently.

The remaining portion of the Detailed Description describes the invention as it is implemented in a hospital emergency room that has an east wing, west wing, and clinic. The clinic is for providing out-patient-type services and for treating very minor injuries and illnesses. One skilled in the art will recognize that the present invention can be implemented in any emergency room regardless of whether it has separate wings or a clinic. One skilled in the art will further realize that the present invention has many applications other than a hospital emergency room.

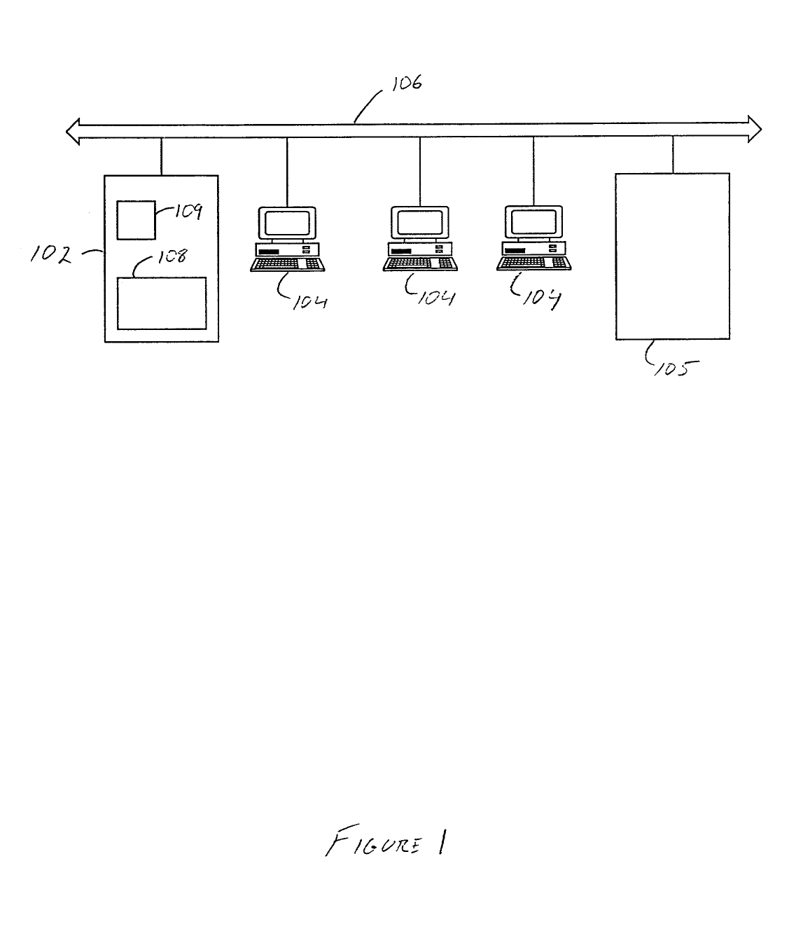

Referring to FIG. 1, the computer system, generally shown as 100, involves a centralized file server 102 and a plurality of remote terminals 104 that preferably are linked together by an ethernet data bus 106 on a Novell network. One skilled in the art will realize that other types of data bases and other types of networks may be used to link the file server 102 and the remote terminals 104. The hospital's mainframe computer 105 that is used for general registration of patients is also linked to the ethernet data bus 106. The interaction between the mainframe computer 105 and the rest-of the system is described in more detail below.

The file server 102 includes a memory 108 for storing data. Preferably, the file server 102 has enough memory 108 to store data for all the patient's visits for the previous two years. One skilled in the art, however, will realize from the detailed description set forth below that the precise amount of required memory will vary depending on the number of patients treated by the emergency room in which the present invention is implemented. The file server also has a RAM 109. Preferably the RAM is 16 megabytes.

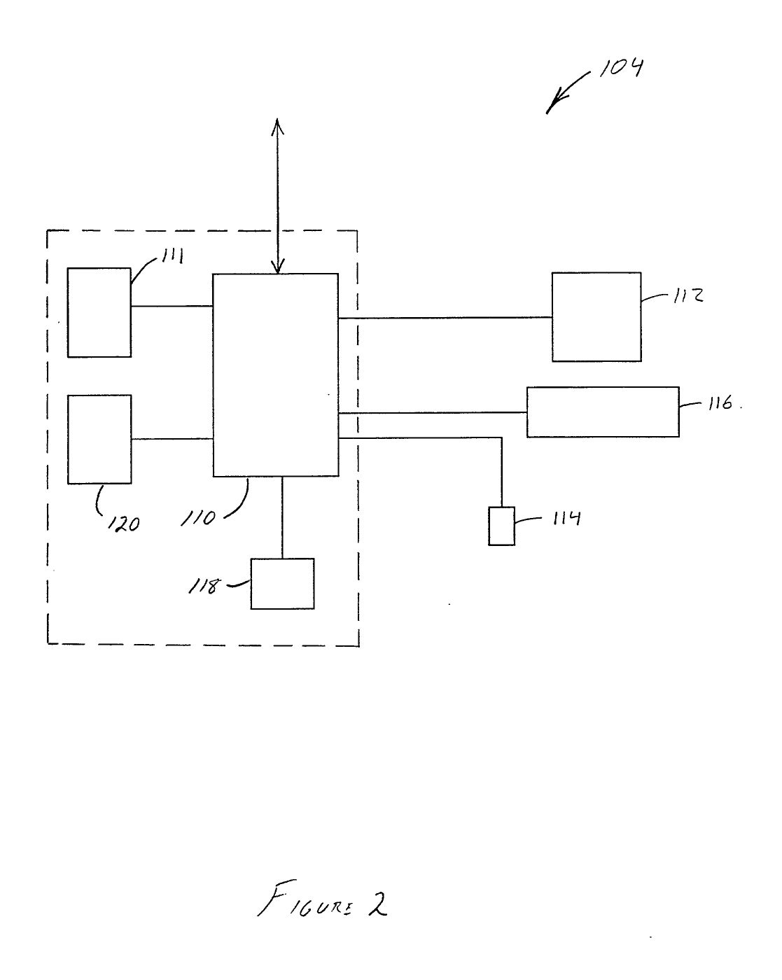

Referring to FIG. 2, each remote terminal 104 has a microprocessor 110, clock 111, monitor 112, pointing device 114, keyboard 116, storage device 118, and at least 4 megabytes of RAM 120. The preferred microprocessor 110 is an Intel 80486 having a clock speed of 33 MHz or higher. Any type of pointing device 114 such as a mouse or light pen can be used, although a light pen is preferred. A monitor 112 with touch sensitive screen can also be used. In this instance, the pointing device 114 is not needed because the user's finger serves the function of the pointing device 114. The remote terminals 104 are preferably placed in strategically located positions throughout the emergency room such as nurse's stations, doctor's lounges, and the registration desk. One skilled in the art will realize that other configurations and microprocessors can be used for the remote terminal 104. A hospital, especially a smaller hospital, might choose to use the present invention with only a single stand alone terminal.

The present invention preferably utilizes a database that operates in a windows environment and is preferably programmed in Superbase version 2.0, which is published by Software Publishing Corporation. The reference manual for Superbase version 2.0, which is entitled Reference Manual, describes the operations and functions in detail and is hereby incorporated by reference. One skilled in the art will realize that Superbase has Structured Query Language capabilities, and thus the present invention may interface with other database systems. One skilled in the art will further realize that the present invention could be programmed using other software packages and languages such as Microsoft Access version 2.0, Lotus Approach version 2.0, Foxpro, Paradox, R:base, Visual Basic, or Visual C++. The computer system 100 preferably uses Windows version 3.1 or higher. The source code that embodies the present invention is attached as Appendix A.

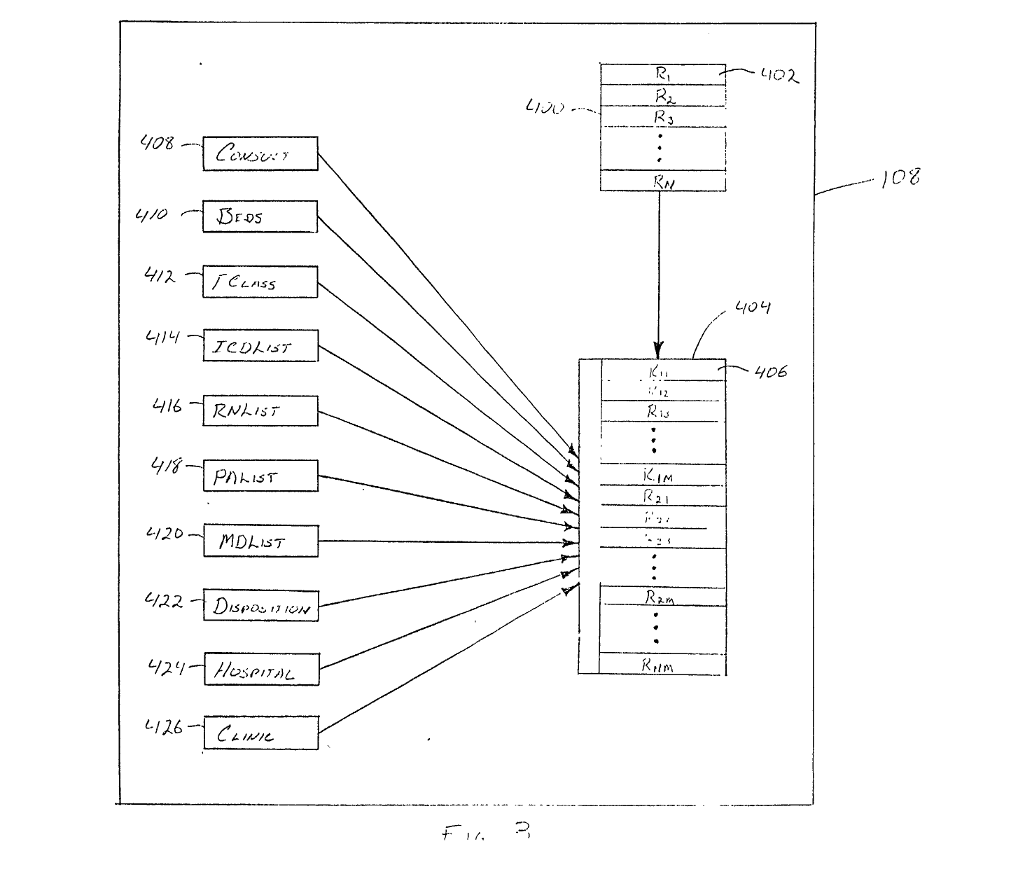

Referring to FIG. 3, the computer system has at least two databases located within the memory 108. The first database is called the Clients database 400 and stores personal information about each patient that visits the hospital emergency room. The data about each patient is organized into a record 402, and each record includes: the patient's first, middle, and last name; the patient's date of birth; the patient's gender; the patient's hospital identification number; and a unique reference code that is used for cross-referencing information between the databases.

The second database is called the Visit database 404 and stores information that is specific to each visit that the patient makes to the emergency room. Information about each visit is stored in a separate record 406. Each record is cross-reference to the patient's personal information record 402 in the Clients database via the unique reference code.

As an example, if a patient has made two visits to the emergency room, he/she will have one personal information record (R₁) in the Client database that contains his/her personal information. The patient will also have two records (R₁₁, and R₁₂) in the Visit database. Both records in the Visit database will contain information that is specific to the particular visit and will be cross-referenced to the patient's record (R₁) in the Clients database.

Each record in the Visit database contains fields for storing the following information related to the patient: the date the patient was admitted to the emergency room; a male/female flag to indicate the patient's gender; a code indicating the patient's financial class; a family/friends data flag indicating whether the patient has family or friends waiting; an ER flag that indicates whether the patient was taken to the emergency room; a clinic flag that indicates whether the patient was taken to the clinic for treatment; the number of the bed to which the patient is assigned; an E/W flag indicating whether the bed is in the east or west wing of the emergency room; the patient's initial complaint; the medical condition of the patient; the medical classification of the patient; the diagnosis of the patient; the code from the International Classification of Diseases (ICD) that denotes the particular diagnosis; the names of the medical staff members who are assigned to provide medical care to the patient; the area of medical specialty that was consulted during treatment of the patient, e.g., ophthalmology, cardiology, dermatology, etc.; a signature flag indicating whether the patient's medical chart was signed; the disposition of the patient, i.e., whether the patient is admitted, discharged, deceased, etc.; the destination of the patient after he/she is discharged, i.e., home, jail, the hospital, etc.; the status of the patient; a discharge time flag, which is set when the patient is discharged from the emergency room; a first time stamp indicating the time the patient was admitted to the emergency room; a second time stamp indicating when the patient was assigned to a bed; and a third time stamp indicating when the patient was discharged from the emergency room.

One skilled in the art will realize that the ICD code is a list of codes that designates certain types of diseases and injuries. The ICD is established by the World Health Organization, an agency of the United Nations. The hospital emergency room must report the ICD codes to the party (insurance company Medicare, Medicaid, etc.) that pays the fees for each patient that it treats. One skilled in the art will further appreciate that the hospital emergency room must also report the financial classification of each of their patients as a part of the accreditation process for medicare and medicaid. The financial class code represents that classification. The possible codes are determined at the state level. The possible medical conditions are I-Critical, II-Emergent, III-Urgent, and IV-Follow Up. The possible medical classifications are NT-Adult Non-trauma, TT-Adult Trauma, PP-Pediatric Non-trauma, and PT-Pediatric Trauma. The possible statuses are P-the patient is registered and awaiting a bed assignment; A-the patient has a bed assignment; I-the patient was discharged, but has an incomplete record; and D-the patient was discharged and their bed needs to be cleaned.

The names of the medical staff includes the initial physician who was first assigned to provide medical care to the patient (initial staff M.D.); if the initial primary physician did not complete the medical care for the patient, the name of the physician that completed the patient's treatment and is responsible for signing the patient's medical chart (sign-out staff); the name of the nurse that is primarily responsible for providing care to the patient; and the name of the resident or medical student that assists the physician during treatment of the patient (PA/resident or PA/G1). If a series of physicians are assigned to provide medical care, the most recent physician, after the initial staff M.D., is considered the sign-out staff. The meaning and purpose of the other data items that are not clear on their face will become readily apparent below.

The patient's record in the Clients database 402 and record in the Visit database 404 that relates to that patient's particular visit are interrelated. Select combinations of information from the Records are configured into pre-determined data structures. Each data structure has a different combination of data items that allows a user to interactively track the patient or information related to the patient in a different way.

The memory 108 also may contain several data arrays, each of which contains a list of pre-determined information that corresponds to a particular type of data item. For example, Consult data array 408 contains a list of the types of medical specialties that might be consulted during the treatment of a patient. Beds data array 410 lists the bed numbers for all of the beds that are located in the emergency room and clinic. FClass data array 412 lists the financial classes that describe the financial standing of the patient. ICDList data array 414 lists the possible ICD codes that can be assigned to a patient and the diagnosis that is represented by each code. RNList data array 416 lists the names of nurses on staff in the emergency room. PAList data array 418 lists the names of the residents and medical students on staff in the emergency room. MDList data array 420 lists the names of the doctors on staff in the emergency room. Disposition data array 422 lists the possible dispositions for a patient. Hospital data array 424 lists the possible hospitals to which a patient might be transferred. Clinic data array 426 lists the possible clinics to which a patient might be transferred.

As explained in greater detail below, the user can copy information from any of the data arrays into the patient's record 406 in the Visit database 408. Each data array 400-426 preferably forms a separate database so that a user or system administrator can easily update the information contained in the data array. Alternatively, any of the data arrays 400-426 can be a set of variable values that are programmed into the source code itself. One skilled in the art will realize that the information stored in the data arrays 400-426 can vary depending on the particular application of the present invention.

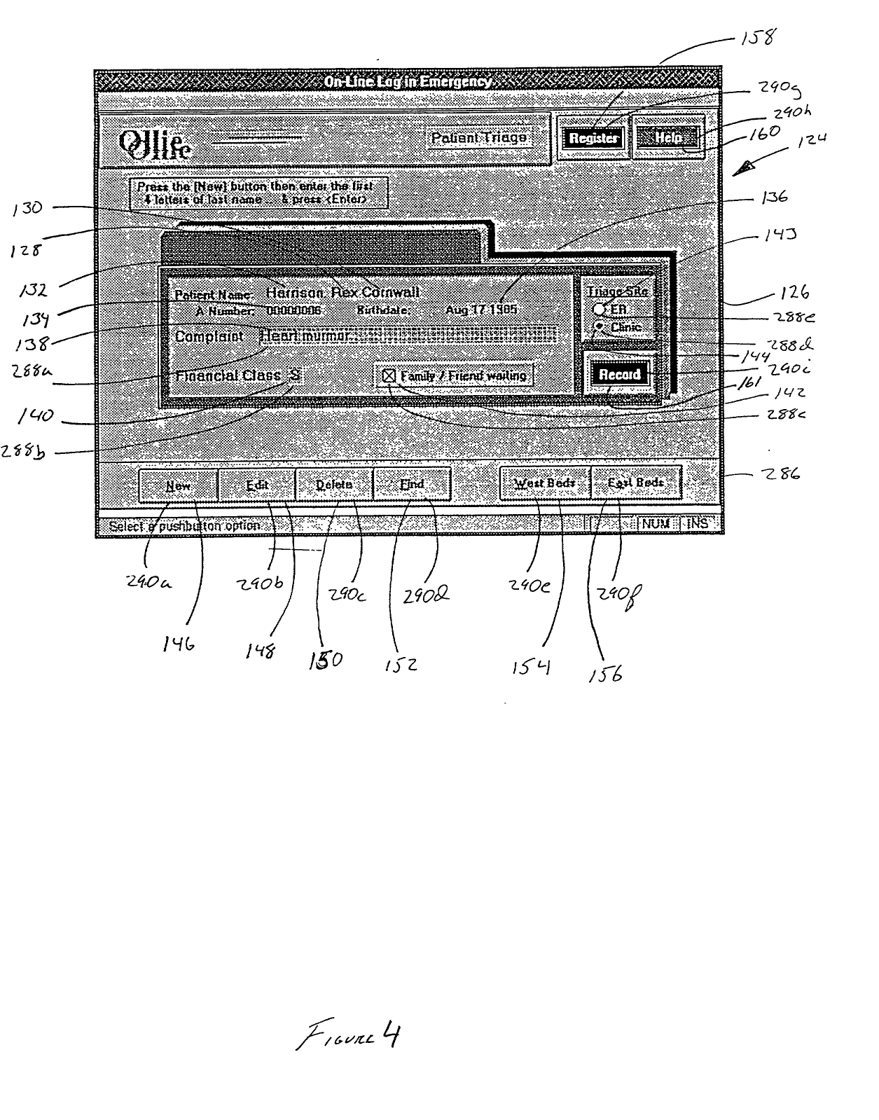

FIG. 4 represents the patient triage data structure, generally shown as 124, which is displayed in the patient triage window 126. Using this figure as an example, the data items from each data structure are formatted in a unique, pre-determined window 286 that is displayed by the monitor 112 of the remote terminals 104. More specifically, each window contains data boxes similar to the data boxes 288a-288e, which are areas in the user interface where the data items are displayed. Each window also contains command buttons similar to the command buttons 290a-290i, which are boxes in the window 286 that the user can activate with the pointing device 114. Some data boxes can contain only a single data item and some data boxes can contain several data items. As described below, the precise number of data boxes and command numbers varies from window to window.

If a particular data item is not yet entered into the memory 108 as a part of a patient Visit record 406, the data box 288a-288e designated to display that data item remains empty when displayed in the window 286. One skilled in the art will realize that a user can edit or enter data by activating any of the data boxes 288a-288e with the pointing device 114 and then entering the new data items or edits to the existing data items on the keyboard 116. If the remote terminal 104 has a touch sensitive monitor, the user can activate the data boxes 288a-288e by simply touching that portion of the screen. Data items in some windows are displayed on the monitor, but are not in a data box. The user cannot edit these data items.

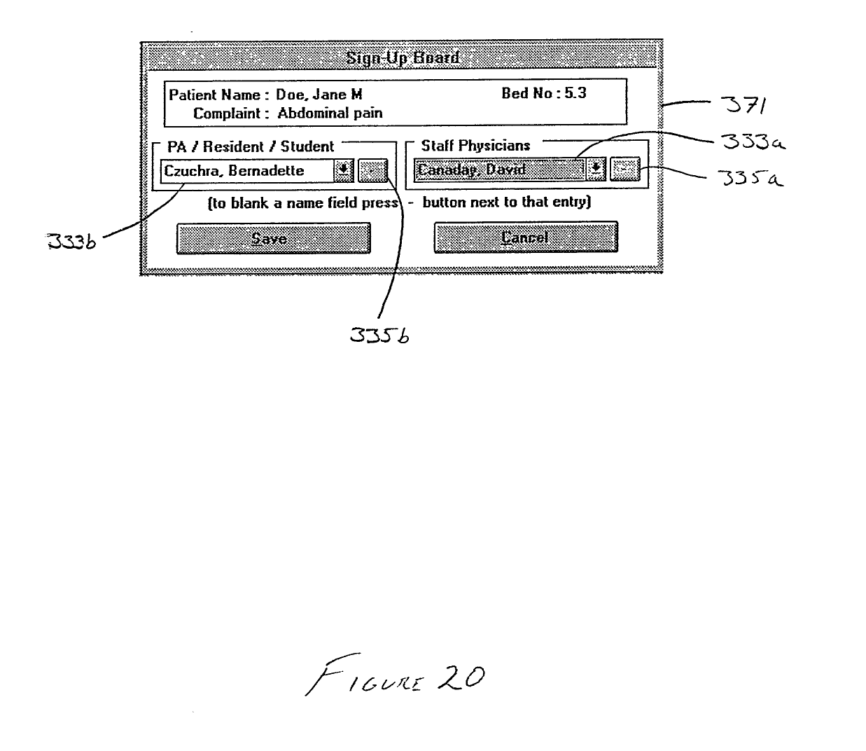

Activating certain data boxes, as identified below, will cause the computer system 100 to display a dialogue box. An example is shown in FIG. 20. The dialogue box 331 includes additional data boxes 333a and 333b that the user can activate to enter or edit information. Each data box 333a and 333b also contains an expansion button 335a and 335b, respectively. Rather than typing data into one of the data boxes 333a or 333b, the user can activate the associated expansion button 335a or 335b, respectively, with the pointing device 114. This action causes the computer system to retrieve and display the related data array 408-426 that contains the possible data items that the user may enter into the main data box. The user can than activate the appropriate data item from the reference list, which causes the computer system to copy that data item into the patient's Client or Visit record 402 or 408, respectively, and display that data item accordingly. For purposes of brevity and clarity these types of data boxes will be called expandable data boxes. One skilled in the art will realize that when a data box is referred to as an “expandable data box” the user can enter information using this procedure.

For purposes of clarity, the Figures for the remaining data structures and windows are not given reference numerals unless the reference numerals are necessary for understanding. In most instances, the description and figures provide reference numerals for the data items that are displayed in the windows. Additionally, the command buttons are identified by the name of the function that they execute when activated by the pointing device 114.

Regarding the specific details of the triage data structure 124, the triage window 126 displays the following data items: the patient's first name 128, middle name 130, and last name 132; the patient's identification number 134, which is called the “A Number”; the patient's birth date 136; the patient's complaint 138; the patient's financial class 140; the family/friends flag 142; the ER data flag 143; and the clinic flag 144. The triage window 126 also includes the following command buttons: New 146, Edit 148, Delete 150, Find 152, West Beds 154, East Beds 156, Register 158, Help 160; and Record 161. The function of these command buttons and the triage data structure 124 will be described below.

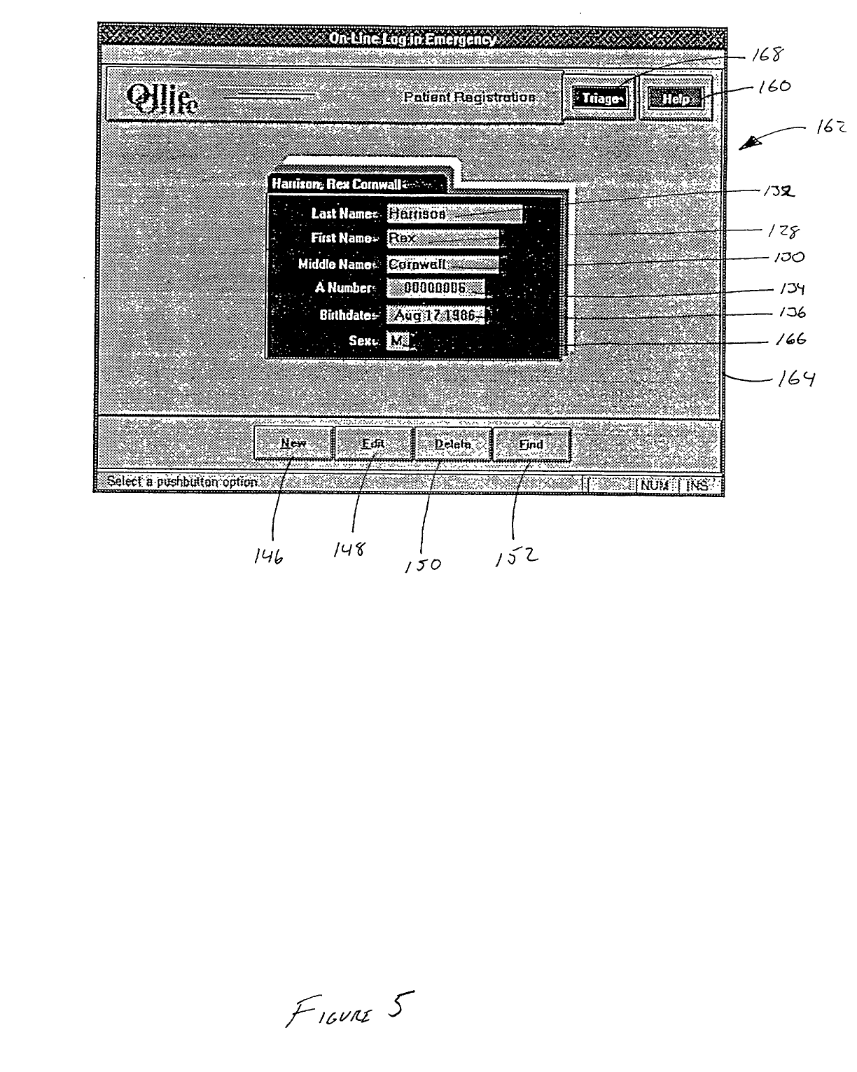

Referring to FIG. 5, the registration data structure, generally shown at 162, is displayed in the registration window 164, which includes the following data items: the patient's first name 128, middle name 130, and last name 132; the patient's identification number 134; the patient's birth date 136; and the male/female flag 166. The registration window 164 also includes the following command buttons: New 146, Edit 148, Delete 150, Find 152, Triage 168, and Help 160. The function of these command buttons and the registration data structure 162 will be described below.

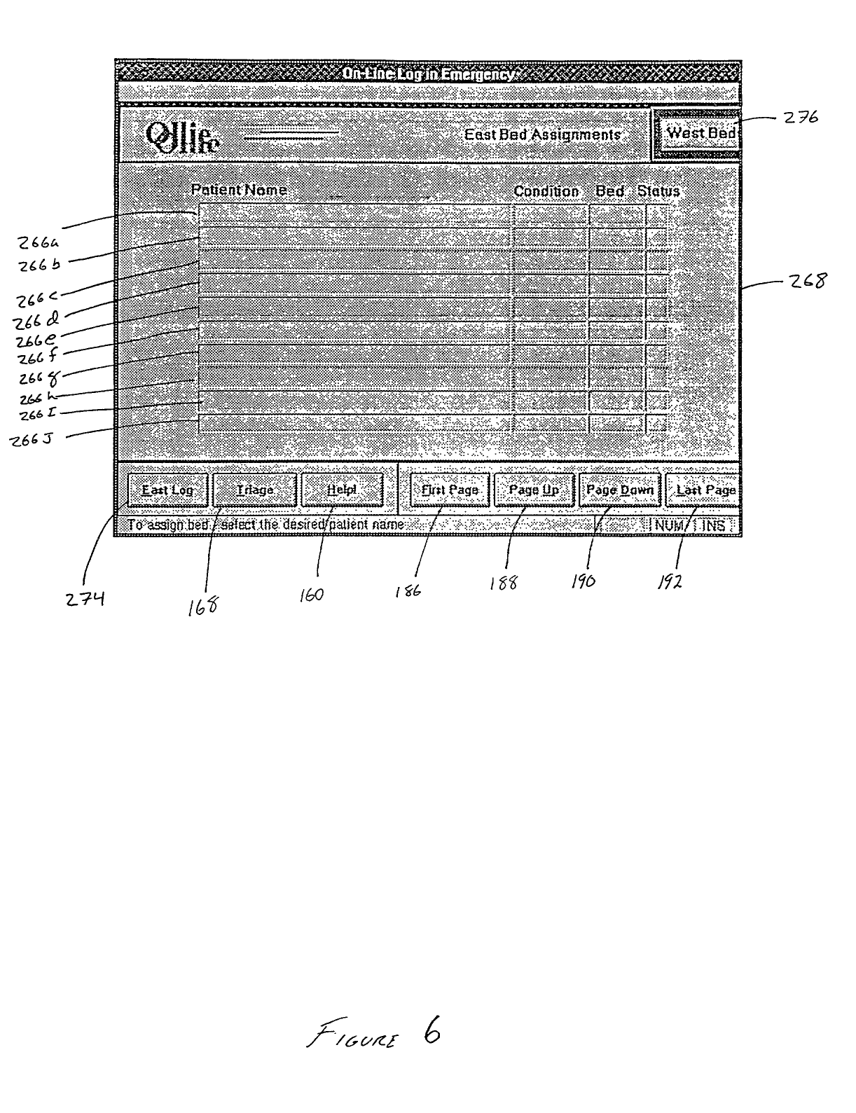

Referring to FIG. 6, bed assignments data structures 266a-266j are displayed in the east bed assignments window 268. Each data structure 266a-266j is displayed on a different line and corresponds to a patient that has been taken to the east wing or west wing, for treatment, rather than the clinic. Each data structure 266a-266j includes the following data items: the patient's first name 128, middle name 130, and last name 132; the patient's medical condition 270; the patient's bed number 178; and the patient's status 272. The east bed assignments window 268 also includes the following command buttons: East Log 274, Triage 168, Help 160, First Page 186, Page Up 188, Page Down 190, Last Page 192, and West Bed 276. The function of these command buttons and the Bed Assignments data structure 266a-266j will be described below.

Although only ten data structures 266a-266j are displayed in the window at one time, the user can scroll the data structures in order to see data items from additional patients who are in the east wing of the emergency room awaiting a bed assignment. One skilled in the art will realize that scrolling through the data structures is accomplished by activating the First Page 186, Page Up 188, Page Down 190, and Last Page 192 command buttons.

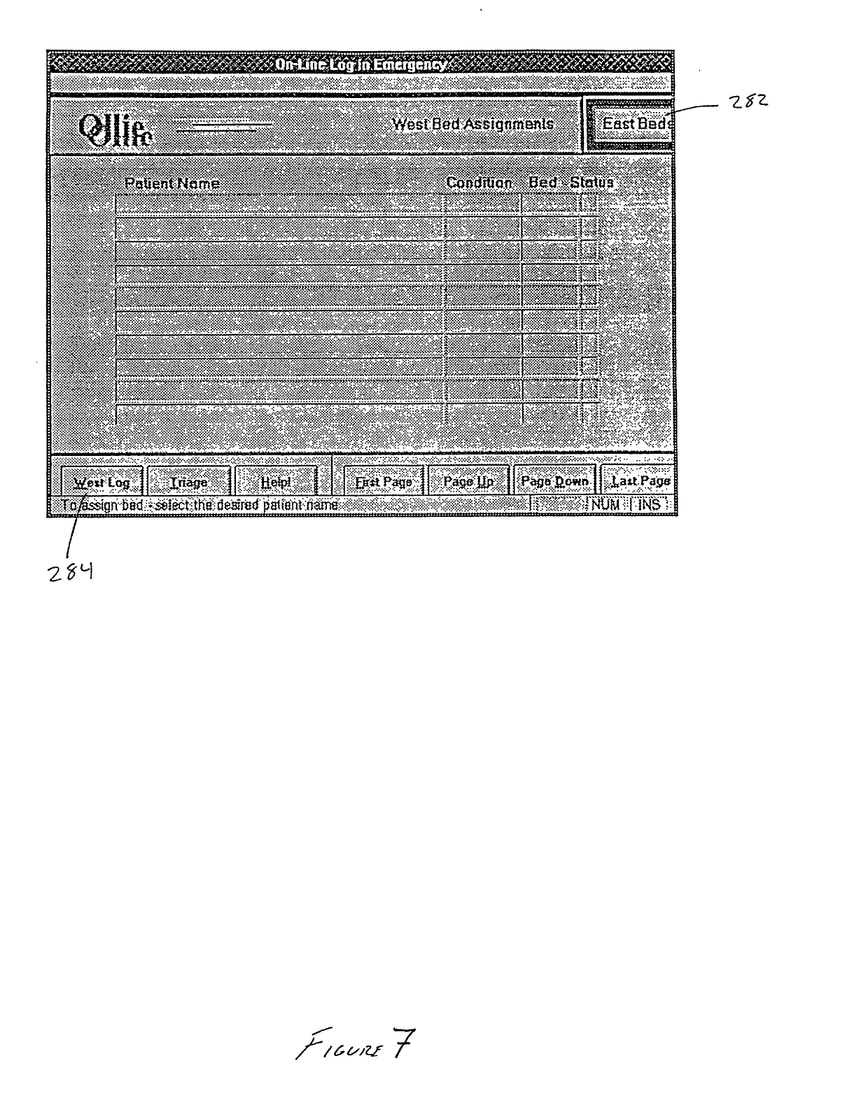

Referring to FIG. 7, the west bed assignments window 280 is substantially identical to the east bed assignments window 268. The primary difference is that the West bed command button 276 and the East log command button 274 are replaced with the East Bed command button 282 and the West Log command button 284.

Patients that are taken to the emergency room for treatment have their bed assignment data structure appear in both the east bed assignment window 268 and the west bed assignment window 280. As described in more detail below, the user can then assign the patient to a bed in either wing. When the patient is assigned a bed in either the east or west wing, the patient's bed assignment data structure will remain displayed in the respective bed assignment window 268 or 280 and will no longer appear in the other bed assignment window 280 or 268, respectively.

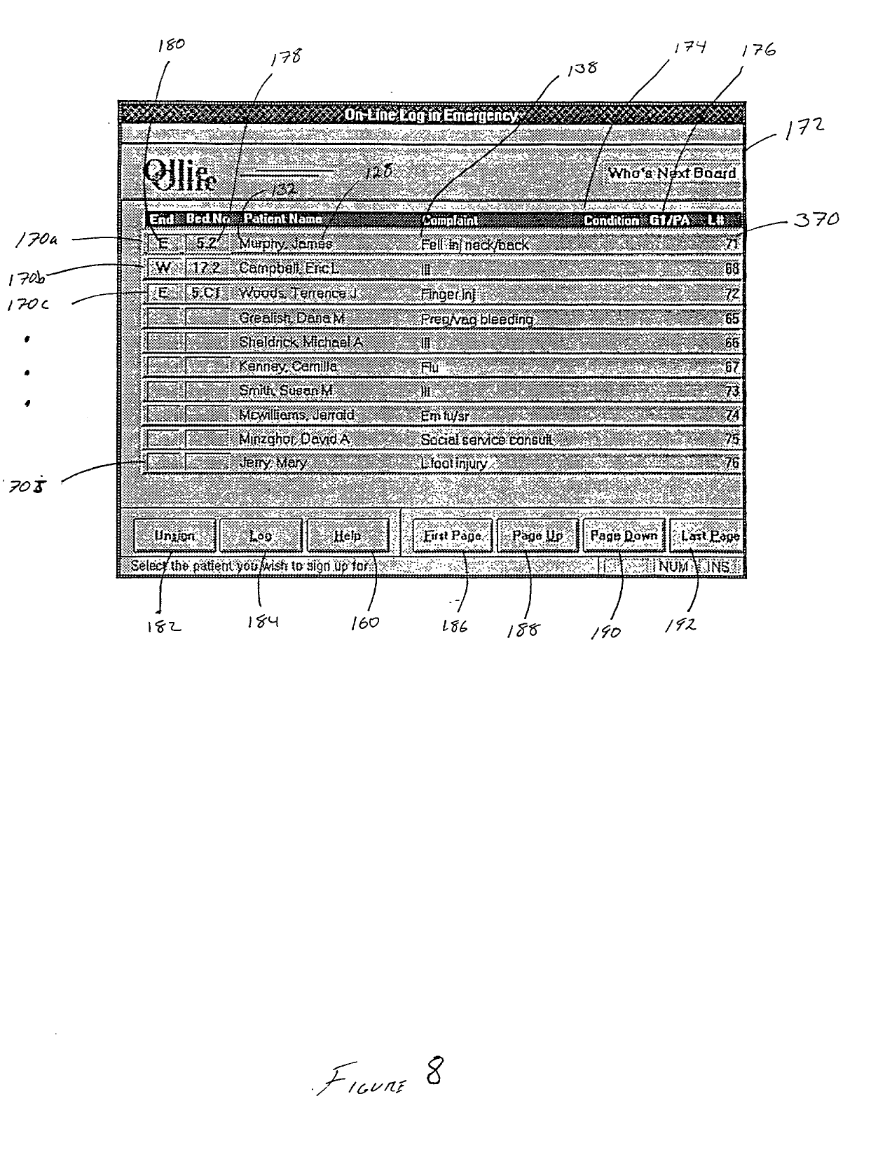

Referring to FIG. 8, the who's next board data structures 170a-170j are displayed in the who's next board window 172. Each data structure 170a-170j is displayed on a different line and corresponds to patients that have been admitted to the east or west wing of the emergency room, but have not yet been assigned an initial staff M.D., i.e., a treating physician. A who's next data structure is not created for patients that are admitted to the clinic because their injury or illness is only minor.

Each data structure 170a-170j includes the following data items: the patient's first name 128, last name 132, and initial from his/her middle name 130; the patient's initial complaint 138; the patient's medical condition 174; the identity of the resident or medical student who will assist the treating physician 176; the number of the bed to which the patient is assigned 178; and the E/W flag 180. The who's next board window 172 also includes the following command buttons: Unsigned 182, Log 184, Help 160, First Page 186, Page Up 188, Page Down 190, and Last Page 192. The function of these command buttons and the who's next board data structures 170a-170j will be described below.

The who's next board window 172 includes the who's next board data structures 170a-170j from all of the patients who are admitted to the emergency room, but have not yet been assigned a physician for treatment. Although only ten data structures 170a-170j are displayed in the window at one time, the user can scroll the data structures in order to see data items from additional patients. Scrolling is accomplished as described above.

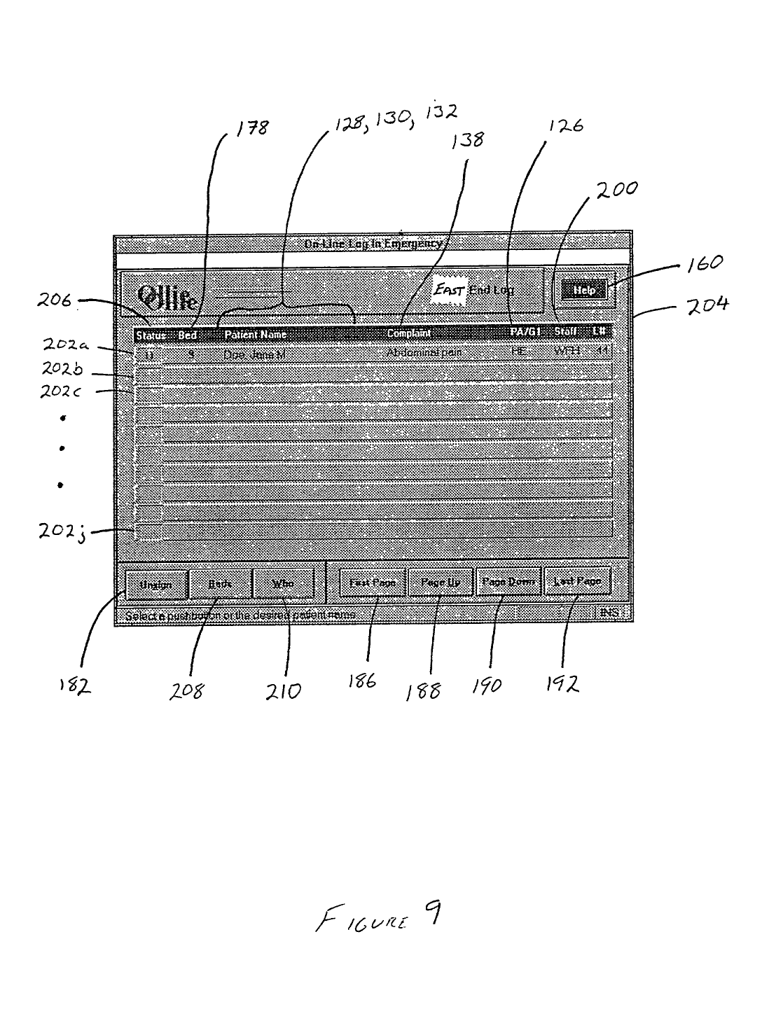

Referring to FIG. 9, the log data structures 202a-202j are displayed in the east end log window 204. Each data structure 202a-202j is displayed on a different line and corresponds to a patient that was assigned a bed in the east wing of the emergency room for treatment as opposed to the west wing or the clinic. Each data structure 202a-202j includes the following data items: the patient's status 206; the bed number to which the patient is assigned 178; the patient's first name 128, middle name 130, and last name 132; the patient's initial complaint 138; the identity of the resident or medical student assigned to assist the physician 126; and the initial staff M.D. 200. The east end log window 196 also includes the following command buttons: Unsigned 182, Beds 208, Who 210, First Page 186, Page Up 188, Page Down 190, Last Page 192, and Help 160. The function of these command buttons and the Log data structures 202a-202j will be described below.

Although only ten data structures 202a-202j are displayed in the window at one time, the user can scroll the data structures in order to see data items from additional patients who are in the east wing of the emergency room. Scrolling is accomplished as described above.

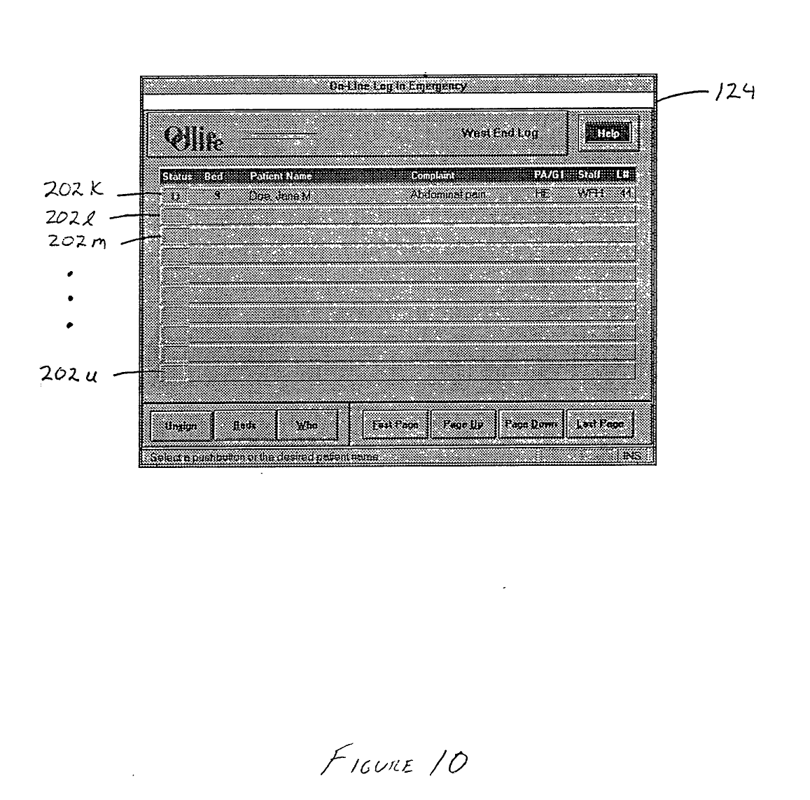

FIG. 10 represents the west end log window 214, which is substantially identical to the east end log window 196. The primary difference is that the west end log window 214 displays the data structures 202k-202u that correspond to patients who were assigned a bed in the west wing of the emergency room rather than the east wing.

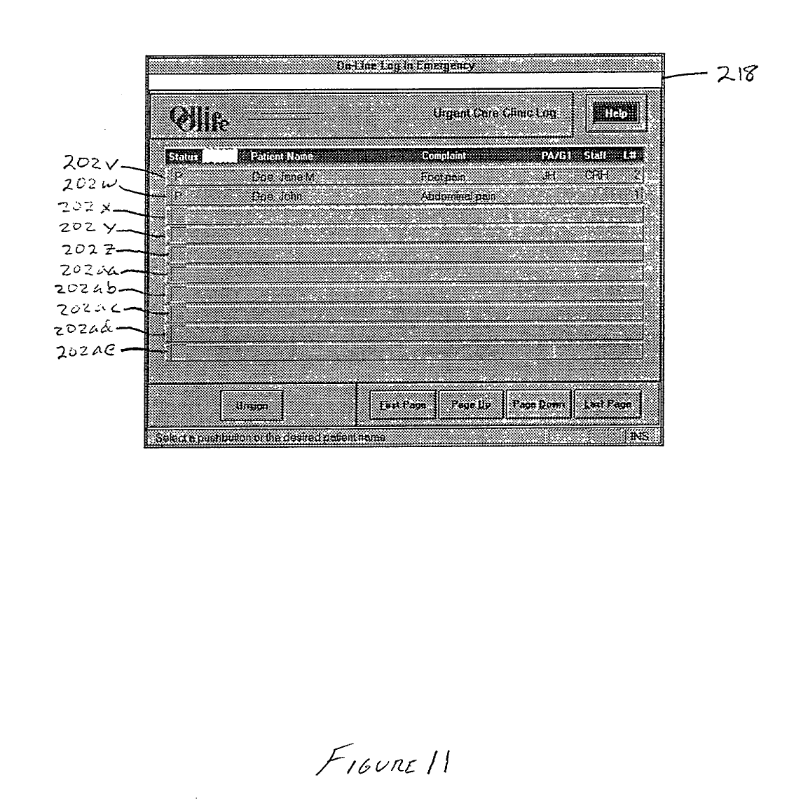

FIG. 11 represents the clinic log window 218, which is substantially identical to the east end log window 196 and the west end log window 214. The primary difference is that the clinic log window 218 displays data structures 202v-202ae that correspond to patients who were sent to the clinic for treatment rather than the east or west wings of the emergency room. The clinic log data structure does not include the bed data item and the clinic log window 214 does not have an area to display such information. Additionally, the clinic log window 218 does not include either the Beds command button 208 or the Who command button 210.

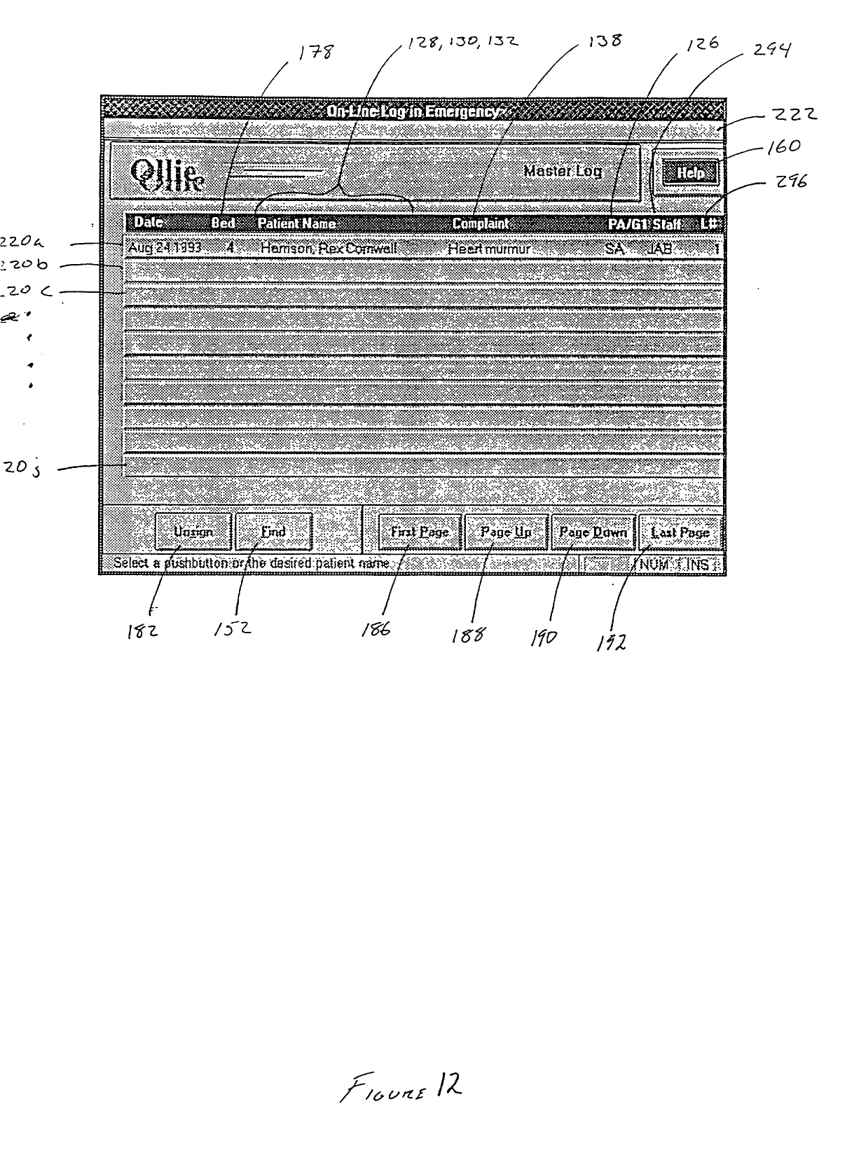

Referring to FIG. 12, the master log data structures 220a-220j are displayed in the master log window 222. Each master log data structure 220a-220j is displayed on a different line and corresponds to a different patient that has been admitted to the emergency room for treatment. Thus, the master log window 222 provides a historical list of the patients that have been treated in the emergency room. In order to conserve space in the memory 108, the master log window 222 might include only patients who were admitted after a certain date.

Each master log data structure 220a-220j includes the following data items: the bed number to which the patient is assigned 178; the patient's first name 128, middle name 130, and last name 132; the patient's initial complaint 138; the identity of the resident or medical student assigned to assist the physician 126; the initials 294 of the initial staff M.D.; and the log number 296 of the patient that identifies the order in which that patient was admitted to the emergency room, e.g., whether the patient was the first, tenth, or twenty-second patient admitted. The master log window 222 also includes the following command buttons: Unsigned 182, Find 152, First Page 186, Page Up 188, Page Down 190, Last Page 192, and Help 160. The function of these command buttons and the master log data structures 220a-220j will be described below.

The master log window 222 only displays ten of the master log data structures 220a-220j at one time. The user can scroll through the data structures in order to see data items from additional patients. Scrolling is accomplished as described above.

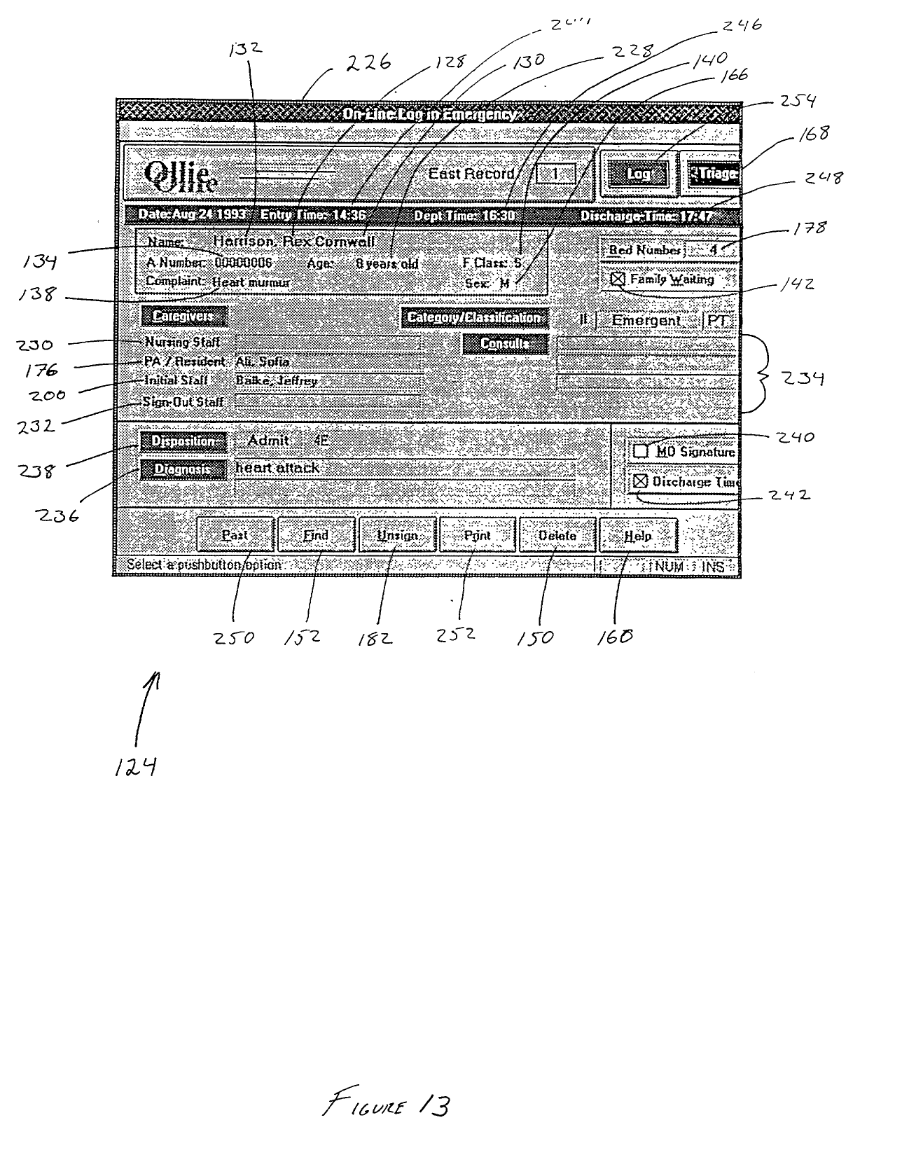

Referring to FIG. 13, the record data structure, generally shown as 224, is displayed in the east record window 226. The record data structure 224 provides comprehensive information about a patient that is being treated in the east wing of the emergency room and includes the following data items: the patient's first name 128, middle name 130, and last name 132; the patient's identification number 134; the patient's initial complaint 138; the patient's age 228, which the processor 110 calculates by comparing the patient's birth date with the current date as it is determined by the clock 111; the patient's financial class 140; the gender flag 166; the bed number to which the patient is assigned 178; the family/friends flag 142; the primary nurse assigned to treat the patient 230; the identity of the resident or medical student assigned to assist the physician 176; the name of the initial staff M.D. 200; the name of the sign-out staff 232, if any; the area of medical specialty that was consulted during treatment of a patient 234 (up to three specialties may be listed); the patient's diagnosis 236; the patient's disposition 238; the signature flag 240, which indicates whether the physician has signed the patient's medical charts; the discharge time flag 242; the first time stamp 244; the second time stamp 246; and the third time stamp 248. The east record window 226 includes the following command buttons: Past 250, Find 152, Unsigned 182, Print 252, Delete 150, Help 160, Log 254, and Triage 168. The function of these command buttons and the records data structure 224 will be described below.

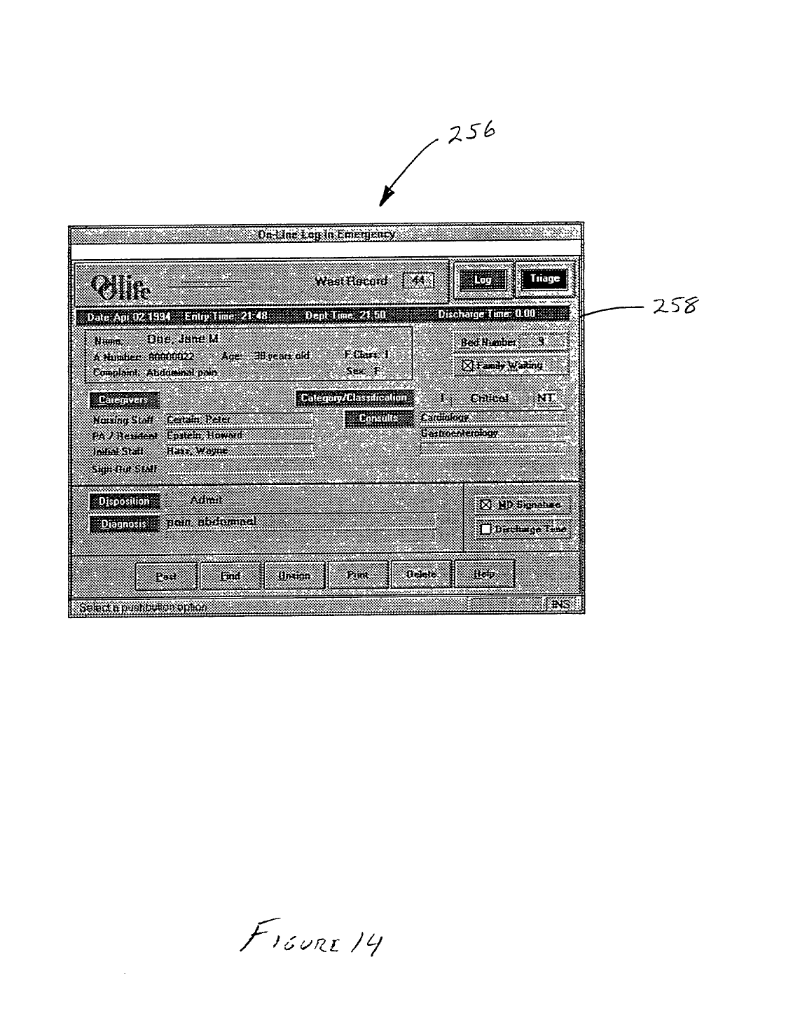

FIG. 14 represents the west record window 258, which is substantially identical to the east record window 226. The primary difference is that the west record window 258 displays the record data structures, generally shown as 256, for the patients that are treated in the west wing of the emergency room rather than the east wing.

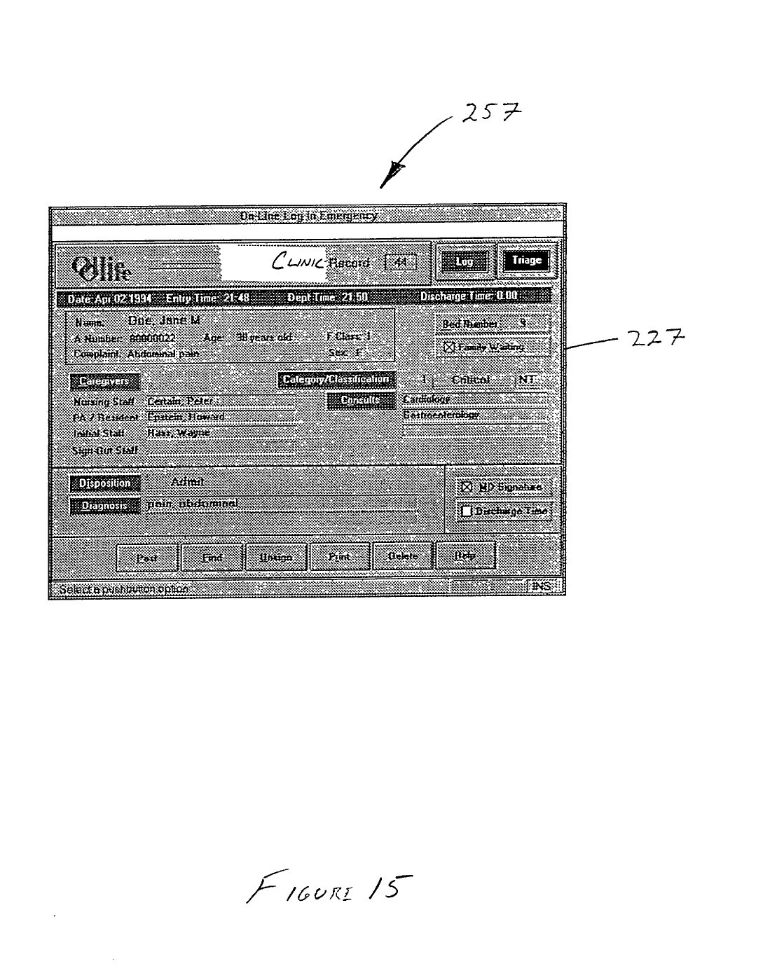

FIG. 15 represents the clinic record window 227, which is also substantially identical to the east record window 226. The primary difference is that the clinic record window 227 displays the record data structure, generally shown as 257, for the patients that are treated in the clinic of the emergency room rather than the east or west wings.

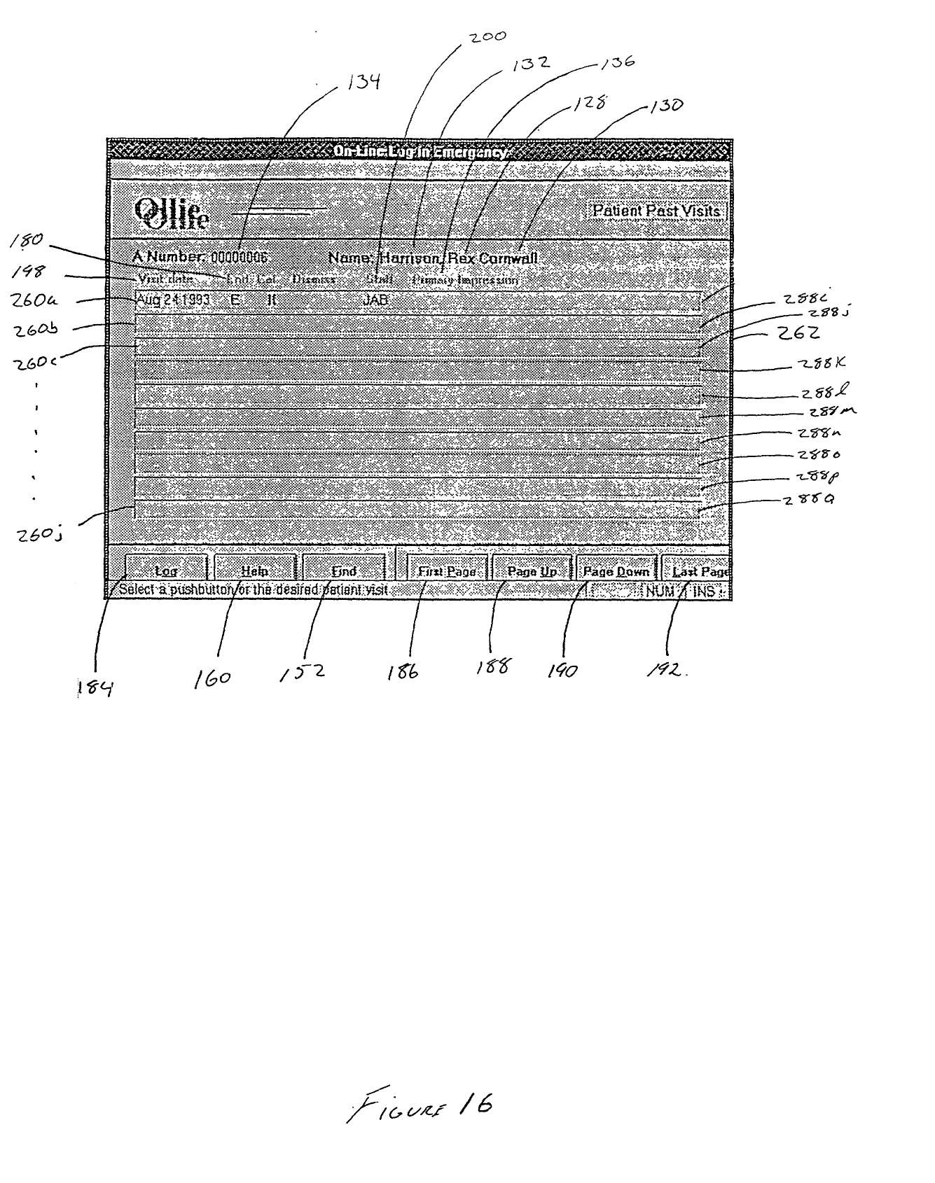

Referring to FIG. 16, the patient past visits data structures 260a-260j are displayed in the patient past visits window 262. The patients past visits window 262 also displays the patient's first name 128, middle name 130, last name 132, and identification number 134.

As discussed above, each visit of a patient has a different Visit record 406 from which the patient past visits data structures 260a-260j are created. Each patient past visits data structure 260a-260j are displayed on a different line. According to FIG. 3, the hypothetical patient Rex Harrison had one past visit that is identified by the patient past visits data structure 260. If the patient had any other past visits, the corresponding patient past visit data structures would have been displayed in the other data boxes 288i-288q. Each patient past visits data structure 260 includes the following data items: the date the patient was admitted to the emergency room 198; the E/W flag 180; the name of the initial staff M.D. 200 that treated the patient; and the patient's diagnosis 136. The patient past visits window 262 also includes the following command buttons: Log 184, Help 160, Find 152, First Page 186, Page Up 188, Page Down 190, and Last Page 192. The function of these command buttons and the patient past visits data structure 260 will be described below.

The patient past visits window 268 does not display more than ten data structures at any one time. Thus, if a patient has more than ten past visits to the emergency room, the user can scroll the data structures in order to see data items from other past visits. Scrolling is accomplished as described above.

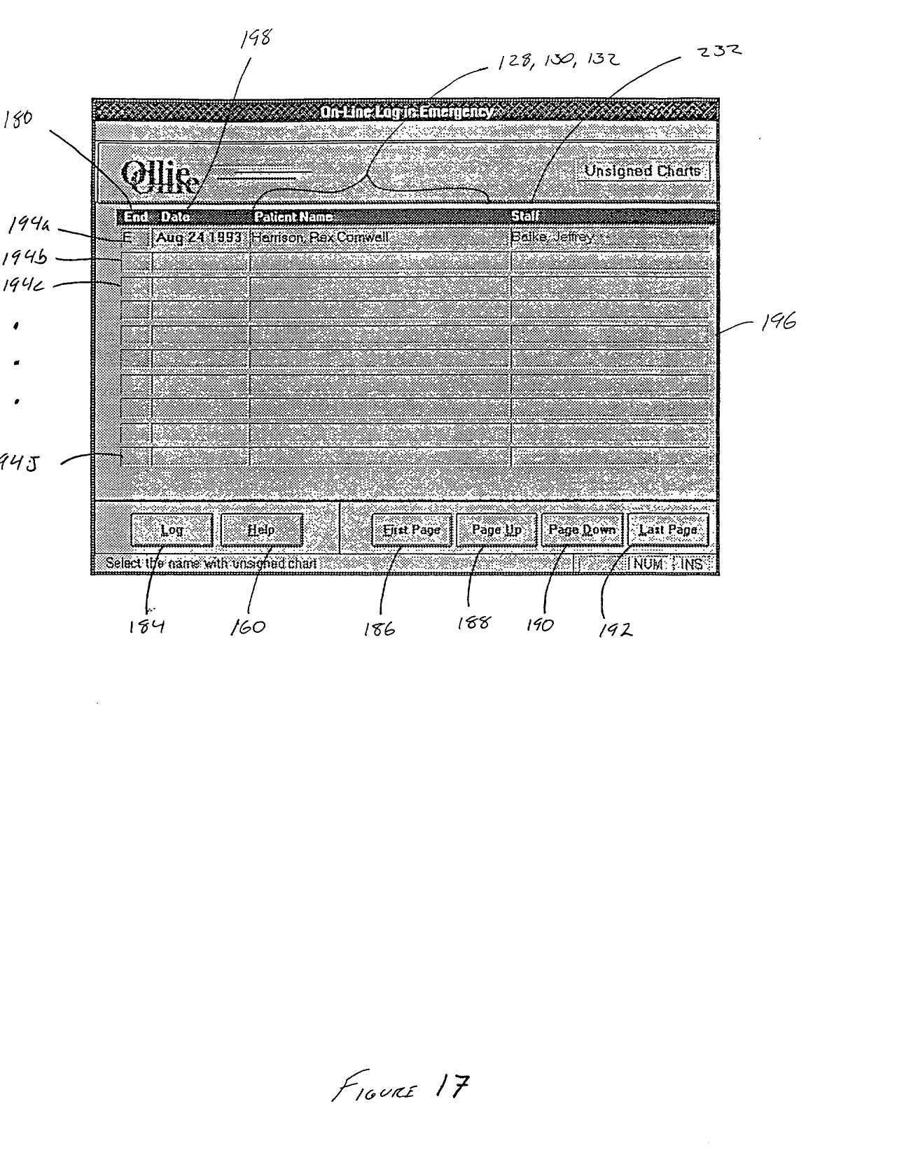

Referring to FIG. 17, the unsigned charts data structures 194a-194j are displayed in the unsigned charts window 196. Each data structure 194a-194j is displayed on a different line and corresponds to the patients whose medical charts were not signed by a physician. Each of the data structures 194a-195j includes the following data items: the E/W flag 180, the date 198 the patient was admitted to the emergency room, the patient's first name 128, middle name 130, and last name 132; and the name of the sign-out staff 232. The unsigned charts window 196 also includes the following command buttons: Log 184, Help 160, First Page 186, Page Up 188, Page Down, 190, and Last Page 192. The function of these command buttons and the unsigned charts data structures 194a-194j will be described below.

The computer system 100 organizes the unsigned charts data structure according to physician. Thus, the unsigned chart window 196 will display only the Unsigned Chart data structures 194 from the patients that were treated by a particular sign-out staff. As described in more detail below, enabling the Unsign command button 182 enables the user to display the unsigned charts data structures 194 for patients that were treated by a different physician. Although only ten data structures 194a-194j are displayed in the window at one time, the user can scroll the data structures in order to see data items from additional patients who have not yet had their charts signed. Scrolling is accomplished as described above.

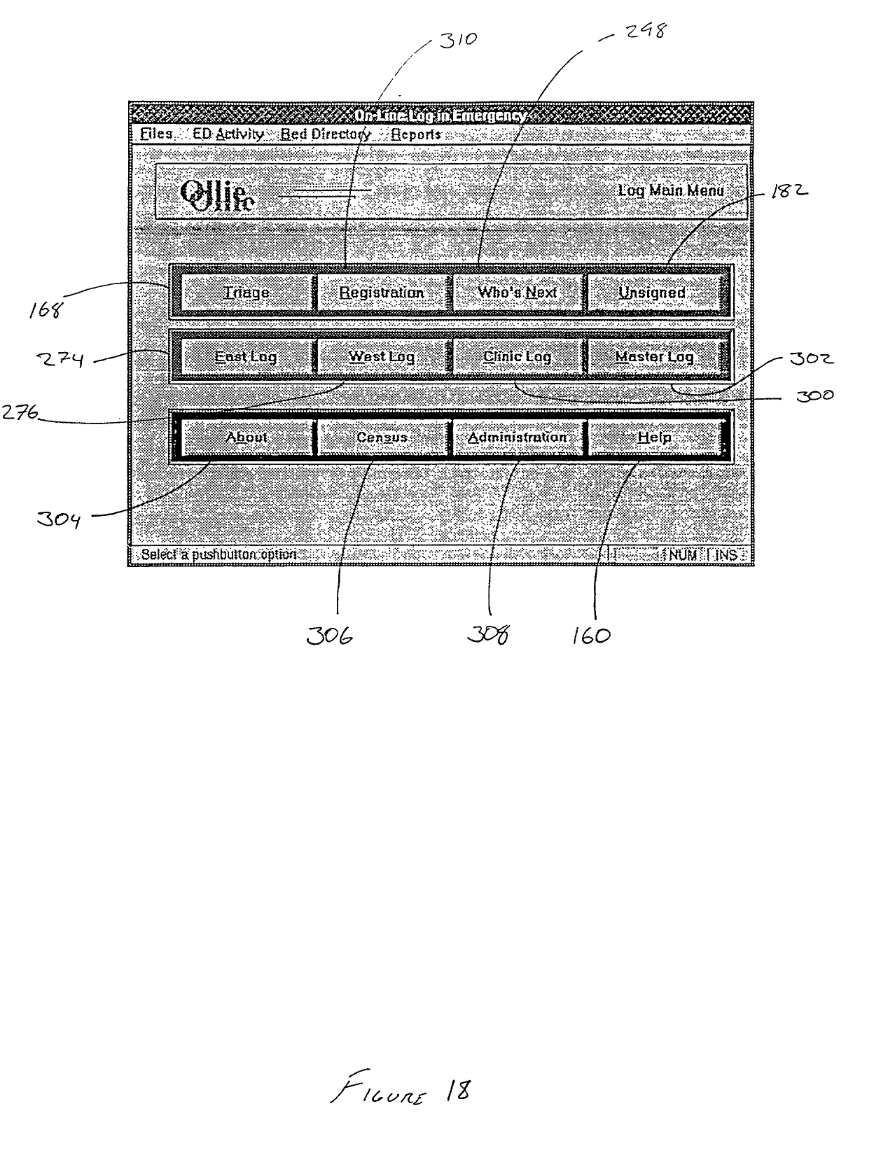

FIG. 18 represents the main menu, generally shown as 312, of computer system 100, which is displayed in menu window 314. The main menu includes the following command buttons: Triage 168, Registration 310, Who's Next 298, Unsign 182, East Log 274, West Log 276, Clinic Log 300, Master Log 302, About 304, Census 306, Administration 308 and Help 160. The functions of the command buttons is as follows. Each command button serves the same function regardless of the window in which it is displayed.

Referring to main menu 312, activating the Triage command button 168 causes the computer system 100 to display the triage window 126 on the monitor 112. Activating the Registration command button 310 causes the computer system 100 to display the Registration window 164 on the monitor 112. The Registration command button 310 and Register command button 158 serve the same function. Activating the Who's Next command button 298 causes the computer system 100 to display the Who's Next board window 172 on the monitor 112. The Who's Next command button and the Who command button 210 serve the same function. Activating the Unsigned button 182 causes the computer system 100 to display the unsigned charts window 196 on the monitor 112. Activating the East Log command button 274, or Master Log command button 276, Clinic Log command button 300, or Master Log command button 302 causes the computer system 100 to display the east end log window 204, west end log window 214, clinic log window 218, or master log window 222, respectively, on the computer system 100. Activating the About command button 304 causes the computer system 100 to display a window that provides information about the present invention including the names of the census inventors and a copyright notice. Activating the Census command button 306 causes the computer system 100 to count the number of Visit records 406 that were opened that day and display that number on the monitor 112. Activating the Administration command button 308 enables the user to access administration information and perform administrative functions. The function of the Administration command button 308 is described in more detail below. One skilled in the art will appreciate that activating the Help command button 160 will cause the computer system 100 to display a help screen on the monitor 112.

Referring to FIGS. 4 and 18, the user will activate the Triage command button 168 from the main menu 312 in order to register a patient who comes into the emergency room. Referring now to FIG. 4, the user activates the New command button 146 and then types the first four letters of the patient's last name and strikes the enter key. The computer system 100 will then generate a list of previous patients that have last names that begin with the same first four letters. The user will then activate the patient's name with the pointing device 114. This action will cause the computer system 100 to automatically display the patient's first name 128, middle name 130, last name 132, birthdate 136, identification number 134, and financial class 140 in the triage window 126. The user must also activate the ER flag 143 if the patient is sent to either the east wing or west wing for treatment, the Clinic flag 144 if the patient is sent to the clinic for treatment, and the Family/Friends flag 142 if the patient has family or friends waiting. All of these flags toggle on and off by activating their respective data box with the pointing device 114. Finally, the user must enter the patient's complaint—the reason the patient came to the emergency room. The user preferably enters the information exactly as it was conveyed by the patient.

Once all of the information is entered into the computer system 100, the user activates the Record command button 316, which creates the Visit record 406 in the visit database, cross-references the Visit record 406 to the patient's record in the Client database, and inserts the displayed data items into the Visit record 122. Activating the Record command button 316 also causes the clock 111 and the processor 110 to create the first time stamp 244 and date stamp 318 that records the day that patient was registered. These additional data items are also inserted into the Visit record 406.

The West Beds command button 154 and the East Beds command button 156 causes the computer system 100 to display the West Bed Assignments window 280 or the East Bed Assignment windows 268, respectively. One skilled in the art will realize the function of the Edit command button 148, Delete command button 150, and Find command button 152. The Edit command button 148 enables the user to edit information that is contained within the triage window 126. The Delete command button 150 allows a patient to delete the record for the patient that is displayed in the triage window 126. The Find command button 152 allows the user to execute queries in order to find certain information within the memory 108. The function of the Help command button 160 is described above.

The registration procedure is slightly more complex if the person was not previously a patient at the emergency room. In this situation, the user must cancel the search through the records in the Clients database. The user then registers the new patient in the hospital's main registration system 105. A record 402 in the Clients database 400 will automatically be created and the mainframe will then download the appropriate information into the newly created record 402. The user can then reactivate the new command button 290a and follow the registration procedure that is outlined above.

If the mainframe is not operating or the link between the mainframe 105 and the ethernet data bus 106 fails, the user must activate the registration command button 310 in order to admit the patient. Activating the registration command button 310 causes the computer system 100 to display the registration window 164 as shown in FIG. 5. The user then manually enters the person's first name 128, middle name 130, last name 132, birthdate 136, financial class 140, and the appropriate gender flag 166. Once this information is entered, the user activates the Triage command button 168, which causes the Triage window 126 to reappear on the monitor 112. The user then enters the remaining data items and activates the appropriate flags. Upon completion of the above steps, the user activates the Record command button 316, which will also create a record 402 in the Clients database. The function of the other command buttons that are included within the registration window 164 were described above.

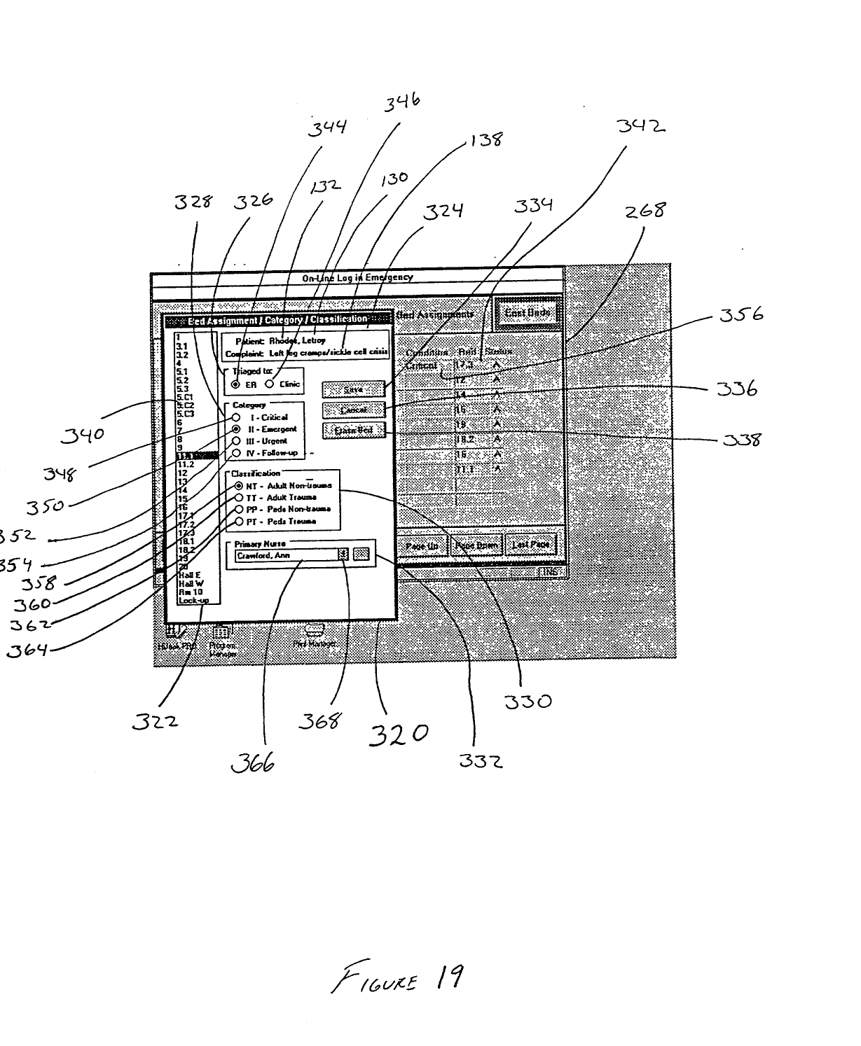

The user can access either the west bed assignments window 280 or the east bed assignments window 268 from the triage window 126. As described above, the patient's bed assignment data structure will appear in both the east bed assignments window 268 and the west bed assignments window 280 until a bed is assigned. In order to assign a bed, the user will display the appropriate window depending on whether he/she means to assign a bed in the east or west wing of the emergency room. For purposes of example, assume the user plans to assign the patient to a bed in the east wing of the hospital. Once the east bed assignment window 268 is displayed, the user can activate the data box with the patient's name and an information window 320 will appear cascaded over the east bed assignments window 268. The Information window is represented in FIG. 19. The Information window contains six dialogue boxes 322, 324, 326, 328, 330 and 332 and three command buttons 334, 336 and 338.

The first dialogue box 322 lists the beds data array 340 that contains all of the bed assignments. The user can activate the number of the bed to which the patient is assigned with the pointing device 114. The bed number then appears in the bed data box 342 in the east bed assignments window 268.

The second dialogue box 324 lists the patient's first name 128, middle name 130, last name 132, and complaint 138. The user cannot edit this information. The third dialogue box 326 contains data boxes 344 and 346 that indicate whether the ER flag 143 or the clinic flag 144, respectively, is set. The user can set the appropriate flag 143 or 144 if it was not set at the time of registration.

The fourth dialogue box 328 contains the possible medical conditions, which were described above, and a data box 348, 350, 352, and 354 that corresponds to each medical condition. The user can activate the data box 348, 350, 352, or 354 that corresponds to the appropriate medical condition for the patient. The medical condition then appears and the condition data box 356 of the east bed assignments window 268.

The fifth dialogue 330 box contains the possible medical classifications, which were described above, and a data box 358, 360, 362, and 364 that corresponds to each medical classification. The user can activate the data box 358, 360, 362, or 364 that corresponds to the appropriate medical classification for the patient. The medical classification does not appear in the east bed assignments window 268.

The sixth dialogue box 332 contains an expandable data box 366 in which the user can enter the name of the primary nurse, which is the nurse that is responsible for attending to the patient and assisting the physician. As described above, the user can activate the Expand button 368 in order to access the RNList data array that lists all of the nurses on staff.

After all of the necessary information is entered, the user can activate the Save command button 334 to insert the information into the patient's record 122 and exit the information window 320; activate the Cancel command button 336, which will disregard the information and exit the information window 320; or activate the Erase Bed command button 338, which will cause the computer system 100 to erase the bed number assigned the patient so that the user can assign a different bed number.

An identical method is used if the patient is assigned a bed in the west wing of the emergency room. The only difference is that the user activates the west bed command button 276 in the triage window 126 rather than the east bed command button 282.

The computer system 100 automatically creates the who's next board data structure 170 when the bed number 178 and medical condition 270 are assigned to the patient. The who's next board data structures 170a-170j are displayed in a hierarchical order. The patients whose medical condition is emergent are placed on the top of the list. If there is more than one patient with an emergent medical condition, the patients are listed according to time of registration with the most recently registered patients being below the other patients with emergent medical conditions. All of the other patients are treated in order of registration. Thus, the most recently registered patients are placed at the bottom of the list.

A physician who finishes treatment of a patient will activate the Who's Next command button 298 from the main menu 312. The physician can also access the who's next board window 172 by actuating the Who command button 210 in either the east end log window 204 or the west end log window 214. The computer system 100 will display the who's next board window 172 on the monitor. The doctor then signs up to treat the patient that is on the top of the list.

Referring to FIG. 20, the doctor accomplishes this task by activating the data box 370 that contains the patient's name. This action causes a dialogue box 371 to appear on the monitor 112. The dialogue box 371 contains the expandable data box 333a for entering the physician's name and the expandable data box 333b for entering the resident's and medical student's name. The dialogue box 371 also displays the patients name, complaint, and bed number. However, the user cannot edit this information within the dialogue box 371. Once the name of the physician, resident, or student is entered, the user can activate either the save button to enter the information into the patients visit record or the cancel button to omit any changes to the data contained within the expandable data boxes 333a or 333b.

Depending on whether the patient is located in the east wing, west wing, or clinic, the user can access and view the east end log window 204, west end log window 214, or clinic log window 218 to view information related to a patient. The user can also enter the status of a patient into the status data boxes 206, 207, and 209 contained in the east log window 204, west log window 214, and clinic log window 218, respectively. The meaning of these status indicators is described above.

If the user needs to review additional information about the patient, he/she can activate the elongated data box that contains the patient's name. This action will cause the computer system 100 to display either the east record window 227, the west record window 258, or clinic record window depending on whether the patient's bed is in the east wing, west wing, or clinic, respectively. These windows are discussed in more detail below. Activating the Beds command button 398 will cause the computer system 100 to display a dialogue box that contains the East Bed command button 156 and the West Bed command button 154.

The user can also view information through the master log window 222, which displays all of the master log data structures 220 for all patients that have been admitted to the hospital emergency room. The user can the record data structure 224 from a patient's particular visit in a manner identical to viewing the record data structure from the east log window 204, west log window 214, or clinic log window 218.

In order to view even more detailed information about a patient, the user can access either the east record window 226, west record window 258, or clinic record window, depending on the location of the patient. Within each of these windows, the user cannot edit the patient's name, identification number, age, financial class, complaint, or the gender flag from this window. The user can edit or enter information related to the bed assignment, the nursing staff, the resident or medical student, the initial staff, the sign out staff, the medical condition of the patient, the medical classification of the patient, the consultant (type of medical specialist consulted during treatment of the patient), the disposition of the patient, or diagnosis of the patient, by activating the appropriate data box.

The user can toggle the family/friends data flag by activating the family waiting data box. The user can also toggle the signature data flag by activating the MD signature data box with the pointing device 114. Finally, the user can toggle the discharge time data by activating the discharge time data box. The user toggles on the discharge time data flag when the patient's bed is cleaned after discharge from the emergency. Toggling the discharge time data flag causes the clock 111 and processor 110 to create the third time stamp, which is stored in the patient's record and displayed in the East Record window.

The user can access the patient's past visits window 262 to view historical information about a particular patient. This window 262 displays the patient's past visits data structure 260 from each of the patient's previous records. If the user desires to view additional information about the previous visit, he/she can use the pointing device 114 to activate the data box that displays relevant patient past visits data structure. This action will cause the computer system 100 to display the record data structure from that previous visit.

Referring to FIG. 17, the user can view a list of patients treated by a particular physician that do not have signed charts. This list is organized by the initial staff M.D. unless a different physician completed the treatment of the patient. In this situation, the patient is listed under the sign-out staff. One skilled in the art will realize that the hospital cannot bill a patient unless the medical charts are signed.

The user can access the listing of unsigned charts by activating the Unsigned command button 182. Referencing to FIG. 21, this action causes the computer system 100 to cascade an Information window that enables the user to enter the name of the doctor for which he/she wants to list the patients that the doctor has treated but has not yet signed their charts. The window contains a first dialogue box 428 that lists the names of the physicians on staff and a second, empty dialogue box 430. The user can either activate the name of a doctor in the first dialogue box 428 with the pointing device 114 or type in the name of the doctor in the second dialogue box 430. The user must activate the O.K. button 434 to the patients whose charts have yet been signed. One skilled in the art will appreciate that he/she can activate any of the buttons 432a-432f in order to scroll names of the physicians listed in the first dialogue box 428.

Upon activation of the O.K. button 434, the computer system 100 will display the unsigned chart data structures 194 for each patient that was treated by that physician and who does not have the signature flag 240 in his/her Visit record 406 activated. The physician can then review and sign the charts for each of the listed patients and access the record data structure 224 from those patients and activate the signature flag 240 within that patient's record 122. This procedure was described above. If the user activates the cancel button 436, the system will erase the information window from the monitor 112 and display a refreshed Main Menu window 303.

While the invention has been described in conjunction with a specific embodiment thereof, it is evident that different alternatives, modifications, and variations will be apparent to those skilled in the art in view of the foregoing description. Accordingly, the invention is not limited to these embodiments or the use of the elements and the specific configurations as presented herein.

The invention that we claim is:

1. A computer system for registering and tracking a patient in a designated treatment area of a medical facility, the system comprising:
a) input means for receiving data items including personal, treatment, and logistical information about the patient;
b) memory means operably connected to the input means for storing the data items;
c) processor means operably connected to the input means and the memory means for creating a record of the data items and for configuring the data items into a data structure that permits interactive tracking of the patient while admitted to the treatment area; and
d) user interface means operably connected to the processor means for displaying the data items from the data structure and for allowing a user to control the processor means for manipulating the data structure, thereby providing real-time logistical tracking of the patient.

2. The system of claim 1 further comprising:
a) at least one array of predetermined data items stored in the memory means; and
b) means for integrating at least one of the predetermined data items into the record.

3. The system of claim 2 wherein the means for integrating includes the user interface means.

4. The system of claim 1 further comprising a file server and at least one remote terminal, the file server including the memory means and the remote terminal including the input means, processor means, and user interface means.

5. The system of claim 4 further comprising a plurality of remote terminals, each remote terminal including one of the input means, processor means, and user interface means.

6. The system of claim 1 wherein the user interface includes a monitor for displaying the data structure, further wherein the processor means generates the data structure in a windows environment having at least one button, the button being operable when activated to modify the data structure.

7. The system of claim 6 wherein the interface includes a mouse for selectively activating the button.

8. The system of claim 1 wherein the medical facility has a centralized database, the computer system further comprising means for operatively connecting the processor means to the centralized database, still further wherein the input means includes means for downloading data items in the nature of personal information related to the patient from the centralized database, thereby creating the record for that patient.

9. The system of claim 1 wherein at least one of the data items is time sensitive in nature, the system further comprising clock means for time stamping the time sensitive data item when the time sensitive data item is stored into the memory means.

10. The system of claim 1 further comprising means for interactively track a plurality of patients.

11. The system of claim 10 wherein the processor means creates a record for each patient and creates an initial data structure for each patient, the system further comprising means for prioritizing the initial data structures, further wherein the user interface means displays the initial data structures in order of priority.

12. The system of claim 11 wherein the means for prioritizing prioritizes patients in order of registration.

13. The system of claim 12 wherein a patient in the designated medical treatment area has a certain medical condition, further wherein the means for prioritizing further prioritizes patients in order of severity of medical condition.

14. The system of claim 1 wherein the input means comprises a keyboard.

15. A method of registering and tracking a patient on a computerized system in a designated treatment area of a medical facility, the method comprising the steps of:
a) receiving data items including personal, treatment, and logistical information about the patient;
b) storing the data items;
c) creating a record of the data items;
d) configuring the data items into a data structure that permits interactive tracking of the patient while admitted to the treatment area;
e) displaying the data information from the data structure; and
f) allowing a user to manipulate the data structure, thereby providing real-time logistical tracking of the patient.

16. The method of claim 15 further comprising the steps of:
a) storing at least one array of predetermined data items; and
b) integrating at least one of the predetermined data items into the record.

17. The method claim 15 wherein computer system operates in a windows environment, further wherein the computer system includes a monitor and a device for interacting with the windows environment, the method further comprising the steps of:
a) creating a button in the windows environment;
b) displaying the button with the information from the data structure; and
c) activating the button, thereby manipulating the data structure.

18. The method of claim 15 wherein the computer system is operably connected to a centralized database, the method further comprising the step of downloading data items in the nature of personal information related to the patient from the centralized database, thereby creating the record for that patient.

19. The method of claim 15 wherein at least one of the data items is time sensitive in nature, the computer system further including clock, the method further comprising the step of time stamping the time sensitive data item when the time sensitive data item is stored into the memory means.

20. The method of claim 15 wherein the computer system further includes records from a plurality of patients, the system further comprising the steps of:
a) creating an initial data structure for each patient;
b) prioritizing the initial data structure for each patient; and
c) displaying the data structures in order of priority.

21. The method of claim 20 wherein the step of prioritizing the initial data structures includes prioritizing the initial data structures in order of registration of the patients.

22. The method of claim 21 wherein a patient in the designated medical treatment area has a certain medical condition, further wherein the step of prioritizing the initial data structures further includes the step of further prioritizing the data structures according to the patient's medical condition.
